(19) United States
(12) Patent Application Publication
(10) Pub. No.: US 2019/0201936 A1
(43) Pub. Date: Jul. 4, 2019

(54) METHOD AND APPARATUS FOR SEPARATING TRICHOMES FROM CANNABIS PLANT MATERIAL

(71) Applicant: WCE LLC, Portland, OR (US)

(72) Inventors: Curtis Rystadt, Portland, OR (US); Carlos Santana, Portland, OR (US)

(73) Assignee: WCE LLC, Portland, OR (US)

(21) Appl. No.: 15/882,903

(22) Filed: Jan. 29, 2018

Related U.S. Application Data
(60) Provisional application No. 62/612,994, filed on Jan. 2, 2018.

(51) Int. Cl. B07B 9/02; B07B 15/00; B07B 1/46

(52) U.S. Cl. CPC B07B 9/02; B07B 1/4609; B07B 15/00

(57) ABSTRACT

Cannabis material is frozen within an inner chamber and agitated, such as by rotating the inner chamber within an outer chamber. Filters limit the passage of cannabis material from the inner to the outer chamber to primarily allow the passage of cannabis trichomes through the filters. Air flows through the outer chamber from an air inlet to an air outlet and entrains the filtered material within an air stream. The entrained material is separated and collected, such as by one or more cyclone separators.

### CROSS REFERENCE TO RELATED APPLICATION

This application claims the benefit of U.S. Provisional Application Ser. No. 62/612,994, entitled METHOD AND APPARATUS FOR SEPARATING TRICHOMES FROM CANNABIS PLANT MATERIAL, filed on Jan. 2, 2018.

This disclosure relates to processing of cannabis plant material, namely to the separation of trichomes from the remaining plant material.

### SUMMARY

In accordance with embodiments of this disclosure, an apparatus for separating trichome containing cannabis materials from cannabis plant material can comprise a first chamber comprising an interior and an exterior and a first chamber access opening communicating from the exterior to the interior of the first chamber. In addition, the apparatus includes a second chamber comprising an interior and an exterior and a second chamber access opening, wherein cannabis plant material is loadable through the first chamber access opening and through the second chamber access opening into the interior trichome containing cannabis material is accomplished by exposing the cannabis material chamber and can be moved to agitate cannabis material positioned therein. In a desirable embodiment, the second chamber is supported for rotation within the first chamber. The second chamber comprises a plurality of filter receiving openings communicating between the interior and exterior of the second chamber. Filter receiving openings refers to openings that are covered by a filter. The second chamber access opening can be one or more of the filter receiving openings that is covered by a filter following the placement of cannabis material therein. A filter covers each of the filter receiving openings. The filters are sized to allow the passage of trichomes from cannabis plant material within the second chamber. It is to be understood that small quantities of trichome sized pieces of non-trichome cannabis material can also pass through the filters, but the trichomes comprise the bulk of the material that passes as very little non-trichome cannabis material will be sized small enough to pass as the second chamber is agitated, such as by rotation. A cooling source inlet is provided through which a cooling material that freezes cannabis material in the second chamber is delivered. This cooling source inlet can comprise a fluid inlet, such as coupled to a source of coolant such as liquid nitrogen, liquid carbon dioxide or a cooling gas. A motor can be coupled to the second chamber and can be operable to rotate the second chamber, such as within the first chamber. The first chamber has at least one or more and desirably a plurality of first chamber outlet openings communicating from the interior to the exterior of the first chamber. A fan comprises a fan inlet and a fan outlet with the fan outlet being coupled to the first chamber for directing air through the first chamber and outwardly through the first chamber outlet openings. Filtered cannabis material containing trichomes dropping to the bottom of the first chamber can be collected in a tray or other container. In addition, filtered material exiting the first chamber outlet openings with the flowing air is separated from the air; with one or more cyclone separators desirably being used to separate out the exiting filtered material from the air. For example, a cyclone separator can comprise a separator inlet coupled to the first chamber outlet opening, the cyclone separator receiving air from the first chamber and collecting material, including trichomes, exiting from the second chamber through the filters. The cyclone separator also comprises a separator outlet that can be coupled to the fan inlet to recirculate cooled air back through the system. A plurality of fans can be used in the system, such as one fan at the separator outlet of each cyclone separator.

To increase the agitation of the plant material and breaking up of the plant material being processed, the second chamber can be provided with plant lifting features that increase the tumbling of plant material within the second chamber. For example, paddles, fins, baffles, tines, flanges or other projections can project inwardly into the second chamber from the walls of the second chamber. These projections assist in lifting the material as the second chamber rotates with the material dropping from the projections as the projections are rotated toward the top of the second chamber. In addition, impact objects can be included with the plant material in the second chamber to assist in breaking up the plant material. These impact objects can, for example, be softballs, lengths of chain, or other durable chunks of material.

The system can be operated as a batch processor wherein plant material to be processed is loaded into the second chamber, processed and them removed following processing with the removed material then being replaced with additional material to be processed. Alternatively, a conveyor can be used to deliver material to be processed to the second chamber and to remove processed material as it is processed on a continuous basis. The cannabis material to be processed can be unprocessed wet, recently harvested cannabis material. Alternatively, the cannabis material can be dried prior to processing by the apparatus. In addition, the apparatus can include a pre-processing section that can break the cannabis material into smaller pieces prior to delivery to the second chamber or prior to depositing onto a conveyor for delivery to the freezing zone of the apparatus. The pre-processing section can comprise, for example, a chipper with rotating blades for breaking up the cannabis material into, for example, pieces of plant material that are on average one inches or smaller in one dimension. A grinder can also be used to pre-process the material into smaller pieces, such as about one fourth inch. The chipper and grinder can be used in series. In addition, the chipper and grinder, if used, can be chilled, such as by cold air or enclosing the components in a refrigeration unit, to reduce the tendency of cannabis material to stick to the machinery. For example, the chipper and grinder can be chilled to thirty-two degrees Fahrenheit or colder.

Less desirably, the system can use air flow to move the processed plant material containing trichomes out of the first chamber and through a screen to capture the trichomes rather than using cyclone separators. Also, gravity can be used to collect the trichome containing plant material in a collection area; for example, the filtered trichome containing plant material can be allowed to settle out of the air by gravity.

In accordance with an aspect of embodiments, the apparatus can also comprise a source of cooling fluid coupled to the cooling source inlet. The cooling source inlet can comprise the second chamber access opening through which solidified carbon dioxide can be added as the cooling material to cannabis material in the second chamber.

In accordance with another aspect of embodiments, the apparatus can comprise an air flow manifold comprising an air flow manifold inlet coupled to the fan outlet, the air flow manifold having at least one air flow manifold outlet coupled to the first chamber through which air from the fan entering the air flow manifold is directed into the first chamber. The first chamber can have a first chamber longitudinal axis and a length direction along the first chamber longitudinal axis. The air flow manifold can extend along a top portion of the first chamber and can extend along at least a majority of the length of the first chamber; the air flow manifold comprising an air flow manifold outlet that directs air flow downwardly from the air flow manifold into the first chamber. The term top portion refers to the upper half of the first chamber, with a more specific example being within thirty degrees either side from the top of the first chamber.

In accordance with a further aspect of embodiments, the second chamber can have a second chamber longitudinal axis and a length direction along the second chamber longitudinal axis, the apparatus comprising a cooling fluid delivery conduit coupled to the cooling source inlet and extending along at least a majority of the length of the second chamber, the cooling fluid delivery conduit comprising a plurality of cooling fluid outlets along the length of the cooling fluid delivery conduit through which cooling fluid is delivered to the interior of the second chamber.

In accordance with additional aspects of embodiments, the first chamber can have a top portion, a first chamber longitudinal axis and a length direction along the first chamber longitudinal axis, and wherein an air flow manifold extends along the top portion of the first chamber along at least a majority of the length of the first chamber and comprises one or more air flow manifold outlets that direct air flow downwardly from the air flow manifold into the first chamber along a majority of the length of the first chamber, and further including a second cooling fluid delivery conduit coupled to the cooling source inlet and extending along at least a majority of the length of the air flow manifold, the second cooling fluid delivery conduit comprising a plurality of cooling fluid outlets along the length of the second cooling fluid delivery conduit through which cooling fluid is delivered to the interior of the air flow manifold for cooling air that flows from the air flow manifold into the first chamber.

The filters for allowing the passage of trichomes from the second chamber as sized to restrict the passage of material other than trichome sized material, with 60 micron to 135 micron filters being a desirable example.

As a further aspect of embodiments, the first chamber has a bottom portion and a length, and wherein there are a plurality of first chamber outlet openings spaced along the length of the bottom portion of the first chamber, and wherein there is a plurality of said cyclone separators each having a separator inlet coupled to a respective one of the first chamber outlet openings and a separator outlet coupled to the fan inlet. The term bottom portion refers to the lower half of the first chamber, with a more specific example being within thirty degrees either side from the bottom of the first chamber.

In accordance with aspects of embodiments, a motor coupled to the second chamber can be operable to rotate the second chamber at a desirable rate, such as at a rate of from 5 to 60 rpm, with one specific example being in the range of from 25 to 50 rpm. The amount of time the second chamber is rotated can be varied, with ten minutes to sixty minutes being an exemplary range.

In accordance with another aspect of embodiments, the apparatus can comprise a temperature probe positioned to measure the temperature within at least one of the first chamber and the second chamber and a display for displaying the temperature.

In accordance with other aspects of embodiments, a motor control can be operated to control a motor to rotate the second chamber after the cannabis material within the second chamber is frozen. As specific examples, the motor control can control a motor after a temperature probe indicates a temperature of below zero degrees Fahrenheit, and more desirably at a temperature of minus 10 degrees Fahrenheit or less.

The apparatus can comprise any combination and sub-combination of the above features.

A method of separating cannabis material containing trichomes from cannabis material in accordance with this disclosure can comprise:

placing trichome containing cannabis material within a chamber:

freezing the trichome containing cannabis material;

flowing air past the chamber;

agitating the frozen trichome containing cannabis material;

filtering the agitated frozen trichome containing cannabis material to allow trichome sized filtered cannabis material, including trichomes, to enter the flowing air; and

separating the filtered material from the flowing air.

As an aspect of an embodiment of a trichome separation method, agitating the frozen trichome containing cannabis material can be accomplished by rotating the chamber containing the frozen trichome containing cannabis material.

As another aspect of a trichome separation method, flowing air can be accomplished by flowing air through a second chamber that encloses the first chamber and wherein separating the filtered cannabis material can comprise passing the flowing air through a cyclone separator.

As a further aspect of a trichome separation method, filtering can be accomplished by requiring frozen cannabis material exiting the chamber to pass through a filter desirably sized to be in the range of from sixty microns to one hundred and thirty five microns.

As yet another aspect of a trichome separation method, freezing the trichome containing cannabis material can be accomplished by exposing the cannabis material to one or more of liquid nitrogen, liquid carbon dioxide or frozen carbon dioxide. A specifically desirable approach is to expose the trichome containing cannabis material to liquid nitrogen.

The above and additional inventive aspects of this disclosure will become more apparent from the description below and the accompanying Figures.

### BRIEF DESCRIPTION OF THE DRAWINGS

FIG. 1 is a block schematic diagram of one embodiment of an apparatus for separating trichomes from cannabis plant material.

FIG. 2 is a front view of an exemplary second embodiment of a trichome separation apparatus with exterior doors closed, the exterior doors covering first openings in a first chamber that communicate from the interior to the exterior of the first chamber.

FIG. 3 is a front view of the apparatus of FIG. 2 with the exterior doors open and with portions of a second chamber visible through the open doors; the second chamber having a plurality of second openings from the interior to the exterior of the second chamber with some of such second openings being shown in FIG. 3 without trichome passing filter material in position to cover the second openings during operation of the apparatus.

FIG. 4 is an interior view, looking toward one end of the second chamber; the second openings also being shown without the trichome passing filter material in place.

FIG. 5 is an isometric view of an exemplary form of a second chamber.

FIG. 6 is a plan view of a filter supporting frame for mounting to the second chamber for supporting the trichome passing filter material over one or more of the second openings.

FIG. 7 illustrates the frame of FIG. 6 with a filter supporting wire mesh shown mounted to the frame.

FIG. 8 is a top view, looking down, of a portion of the frame of FIG. 6 with the mesh of FIG. 7 and with filter material in position and showing the structure mounted to the second chamber with the filter material overlying one or more of the second openings; the frame, filter supporting screen and filter material comprising a form of filter structure.

FIG. 9 is a front view of the frame and screen of FIG. 7.

FIG. 10 illustrates a front view of the apparatus with the exterior doors open and with respective filter structures shown installed to cover the second openings of the second chamber.

FIG. 11 is a top view of the apparatus of FIG. 2.

FIG. 12 is a view of a first end of the apparatus of FIG. 2.

FIG. 13 is a back view of the apparatus of FIG. 2.

FIG. 14 is a view of a second end of the apparatus of FIG. 2 opposite to the first end shown in FIG. 12.

FIG. 15 is a close-up view of outlets from the first chamber of the apparatus of FIG. 2 shown coupled to trichome separators; which in the form shown in this embodiment comprise cyclone separators.

FIG. 16 illustrates a pivot support for the second chamber which allows rotation of the second chamber.

FIG. 17 illustrates an exemplary control circuit for the apparatus of FIGS. 1 and 2.

FIG. 18 illustrates an exemplary trichome separation process that can be implemented by the apparatus of FIG. 1 or FIG. 2.

### DETAILED DESCRIPTION

Throughout this disclosure, when a reference is made to a first element being coupled to a second element, the term “coupled” is to be construed to mean both direct connection of the elements as well as indirect connection of the elements by way of one or more additional intervening elements. Also, the singular terms “a”, “and”, and “first”, mean both the singular and the plural unless the term is qualified to expressly indicate that it only refers to a singular element, such as by using the phase “only one”. Thus, for example, if two of an element are present, there is also “a” or “an” of such element that is present. In addition, the term “and/or” when used in this document is to be construed to include the conjunctive “and”, the disjunctive “or”, and both “and” and “or”. Also, the terms “includes” and “has” have the same meaning as “comprises” and the terms “including” and “having” have the same meaning as “comprising”. Numerical values set forth in this disclosure and in the drawings are exemplary; except to the extent included in any claims that specifically recite such values.

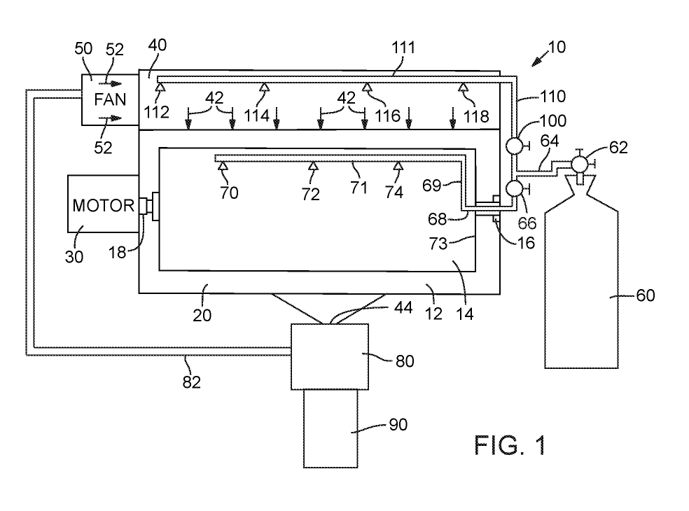

With reference to FIG. 1, an exemplary embodiment of a trichome separator in accordance with this disclosure is indicated at 10. The cannabis material to be processed need not be pre-dried, (although it can be pre-dried), as the system advantageously can process just harvested fresh or wet, or recently harvested undried (not subjected to drying by a dryer) cannabis material. Cannabis trichomes are extremely small and typically range in size from 40 microns to 155 microns, with an extremely high percentage of trichomes being from 40 to 120 microns. The term trichome sized material refers to material that will pass through a one hundred and fifty micron filter. More that one filter size can be used in the apparatus; for example cannabis material passing from the second chamber can be processed through successively smaller sized filters to further refine the material (such first filters of about 120 micron filters, second filters of about 80 micron filters and third filters of about 60 micron filters; the term about meaning within plus or minus 10 percent of the stated value or size). Unless qualified by the term exactly, any value set forth in the claims below are to be interpreted to mean “about” the recited value.

The apparatus of FIG. 1 comprises a first chamber or housing 12 and a second chamber 14. The second chamber comprises a chamber or container for use in holding cannabis material and for agitating the cannabis material when frozen to separate trichomes and pass the trichome sized cannabis material containing trichomes through filters that restrict the passage of larger sized cannabis material. The second chamber can be supported for rotation and is desirably rotatable within the first chamber 12. In the illustrated embodiment, bearings 16, 18 rotatably support the first chamber for rotation about the longitudinal axis of the first chamber.

The interior of the first chamber 12; and desirably at least at the bottom portion 20 thereof, comprises an area or volume in which trichome sized cannabis material containing trichomes passing from cannabis material positioned within the second chamber enter during processing. A motor 30 is shown coupled to the second chamber for use in rotating the second chamber. The motor typically includes a gear box to reduce motor speed and increase torque. Less desirably; instead of rotatably supporting the second chamber, the second chamber can be supported for vibrational movement or shaking movement within the first chamber. For example, the second chamber can be axially slidable along a shaft and coupled to a motor for moving the chamber back and forth along the shaft to shake the contents within the second chamber.

An air flow manifold 40 can be coupled to the first chamber 12. The illustrated manifold 40 is positioned along the top of the first chamber and can extend in a lengthwise direction of the first chamber; such as parallel to the longitudinal axis of the second chamber. The manifold 40 in this example comprises a plurality of air flow outlets, some of which are numbered as 42 in FIG. 1 through which air can flow from the manifold 40 into the first chamber 12. The outlets 42 can be slots, or openings of any shape; and are desirably positioned to distribute the air flow downwardly from the manifold and throughout the first chamber 12 and to one or more first chamber outlets; one such outlet being shown as outlet 44 in FIG. 1. The airflow through the chamber 12 is generally from top to bottom with air also flowing through the chamber or drum 14 positioned at least in part between the inlets 42 and one or more outlets 44 of the chamber 12. In FIG. 1, only one outlet 44 is shown. However, a plurality of such outlets 44 are described below in connection with an alternative embodiment.

A fan 50 directs air flow in the direction indicated by arrows 52 into the manifold 40. A plurality of fans 50 can be used; such as one associated with each cyclone separator included in a plural cyclone separator apparatus.

In accordance with this disclosure, cannabis material introduced or delivered to the interior of the second chamber 14 is subjected to freezing temperatures. In one specific approach, a liquid nitrogen tank 60 having a valve 62 communicates via a conduit 64 to a valve 66. When valves 62 and 66 are open, liquid nitrogen passes through the valve 62, the conduit 64, the valve 66 and through a conduit section 68 (through a first end 73 of second chamber 14), and through conduit sections 69 and 71 into the interior of the chamber 14. Conduit section 71 desirably extends along at least a majority of the length of the second chamber 14 (at least fifty percent); and more desirably along substantial portion (seventy to ninety percent) or the entire length of the second chamber 14. A plurality of outlets 70, 72 and 74, (more or fewer outlets can be utilized) distribute the cold liquid nitrogen into the cannabis material within chamber 14 to freeze this material. Desirably, the temperatures are low enough to flash freeze the material. Desirably temperatures of below 0 degrees Fahrenheit are achieved within the second chamber 14; with more desirable temperatures being below 10 degrees Fahrenheit and a more desirable range of temperatures being from minus 15 degrees Fahrenheit to minus 30 degrees Fahrenheit.

Although not required, as an alternative or as an additional cooling source, the tank 60, valve 62, and conduit 64 can be coupled through a second valve 100, and conduit section 110 to a conduit section 111 extending lengthwise into the airflow manifold 40. Conduit section 71 desirably extends along at least a majority of the length of the manifold 40 (over fifty percent); and more desirably along substantial portion (seventy to ninety percent) or the entire length of the manifold 40. A plurality of outlets 112, 114 and 116 (more or fewer outlets can be utilized) distribute the cold liquid nitrogen into the air flow manifold to cool the air flowing through the manifold which enters the first chamber 12 and cools the cannabis material within chamber 14 to freeze this material.

The second chamber 14 has at least one opening and more desirably a plurality of openings as described below throughout its surface wall from the interior to the exterior of the second chamber. These openings can serve as access openings for the introduction of cannabis material into the interior of the chamber 14 or alternatively, a separate access opening can be provided in the chamber 14. The openings are desirably covered by a filter through which trichome sized cannabis material containing trichomes passes to exit the chamber 14 and enter the first chamber and then pass toward the outlet 44. The filter is sized to allow the passage of the desirable trichomes and trichome sized cannabis material, most of which will be trichomes, while restricting the passage of larger sized cannabis material remaining in the second chamber. Small sized fragments of non-trichome material can also pass through the filters with such non-trichome material passage being minimized. This is accomplished by selecting a filter size of desirably between 60 and 135 microns, with 70 to 120 micron filters being particularly desirable; and with one specific example being a 120 wire mesh screen that comprises a form of 117 micron filter.

Desirably, after the temperatures within chamber 14 reaches the desired level to freeze the material therein, such as minus 15 degrees Fahrenheit, the motor 30 is operated to rotate the drum or chamber 14 within chamber 12. This rotation agitates the plant material and frees trichomes from the remaining cannabis material so that the trichomes and trichome sized cannabis material can pass through the filters and from the interior of the second chamber. Gravity and air flow assist in moving the cannabis material containing trichomes s through the filters. The air flow moves the filtered cannabis material containing trichomes to the outlet 44 with the cold temperatures within the first chamber (caused by the cooling fluid entering conduit 71 and/or conduit 111 if used) assisting in preventing the trichomes from adhering to the walls of the first chamber.

A material separator 80 is positioned at the outlet 44 with an air flow conduit 82 being coupled from separator 80 to the fan 50 such that, in this embodiment, air is recirculated from the fan through the apparatus and back to the fan. The conduit 82 can be insulated to assist in maintaining the desired cold temperatures within the apparatus.

Although other forms of separators can be used, a desirable form of separator is a cyclone separator; such as a commercially available cyclone separator from Oneida Air Systems of Syracuse, N.Y., with model AXD002030AXL being one specific example.

Although the rate can be varied, the second chamber is desirably agitated slowly, such as rotated at a slow rate, such as from 5 to 60 RPM. A rotation rate of 25 to 50 RPM is one specific example of a range of rotational speeds suitable for a trichome separating apparatus utilizing liquid nitrogen as a cooling source, with 40 RPM being one specific exemplary speed.

The separated cannabis material containing trichomes from separator 80 are deposited within a collection container, such as a bin or barrel coupled to the separator with one such container being indicated at 90 in FIG. 1.

The cannabis material can be processed by the separator apparatus a plurality of times before the remaining material is removed from the interior of the second chamber. For example, initial processing can separate the cannabis material containing the highest quantities of trichomes, and thereby the most valuable material for collection and removal. Further processing of the same cannabis material can be repeated one or more additional times. Second and further processing results in lower grade material as more of the non-trichome cannabis plant material will pass through the filters the more the process is repeated.

Following processing, operation of the apparatus is halted and the remaining cannabis plant material is removed from the interior chamber 14 with the process then being repeated with a subsequent batch of material. The system can be operated as a batch processor wherein plant material to be processed is loaded into the second chamber, processed and them removed following processing with the removed material then being replaced with additional material to be processed. Alternatively, a conveyor can be used to deliver material to be processed to the second chamber and to remove processed material as it is processed on a continuous basis.

As an alternative, a continuous process can be utilized with a belt or other mechanism introducing the cannabis material into the chamber 14 and another belt removing the material from the chamber on a continuous basis.

As an alternative, for example, in a location where liquid nitrogen is not readily available, one can utilize an alternative cooling approach to freeze the cannabis material within the second chamber 14. For example, at the time the cannabis material is placed in the interior or second chamber 14, or shortly before or thereafter, dry ice material (dry carbon dioxide) can be placed in the inside of interior chamber 14 to accomplish the desired cooling of the cannabis material inside of the second chamber. As additional alternatives, other cooling fluids, such as liquid carbon dioxide, can be used and/or combinations of dry ice and liquid cooling fluid, such as dry ice in combination with liquid nitrogen, liquid carbon dioxide, and/or other cooling fluids.

In the approach utilizing dry ice within the interior chamber as a cooling source, the interior chamber or drum is typically rotated at a reduced rate, such as at 5 RPM to 10 RPM, to mix the dry ice with the cannabis material therein. In general, one does not want to agitate the cannabis material within the interior chamber too much before the material is frozen. Therefore, in a desirable approach, agitation of the cannabis material is delayed until the temperature within the apparatus is at a desirable level below freezing, such as below zero degrees Fahrenheit, with a specific example being starting rotation of the second chamber when the temperature within the first and/or second chambers reaches minus 10 degrees Fahrenheit.

Cannabis trichomes are a rich source of cannabinoids, turpines and flavonoids from cannabis material. Bulbous trichomes are typically 10 to 15 microns in size and capitate sessile trichomes are slightly larger in size. In contrast capitate-stalked trichomes, until they are broken up, are much larger, typically 50 to 100 mm in size.

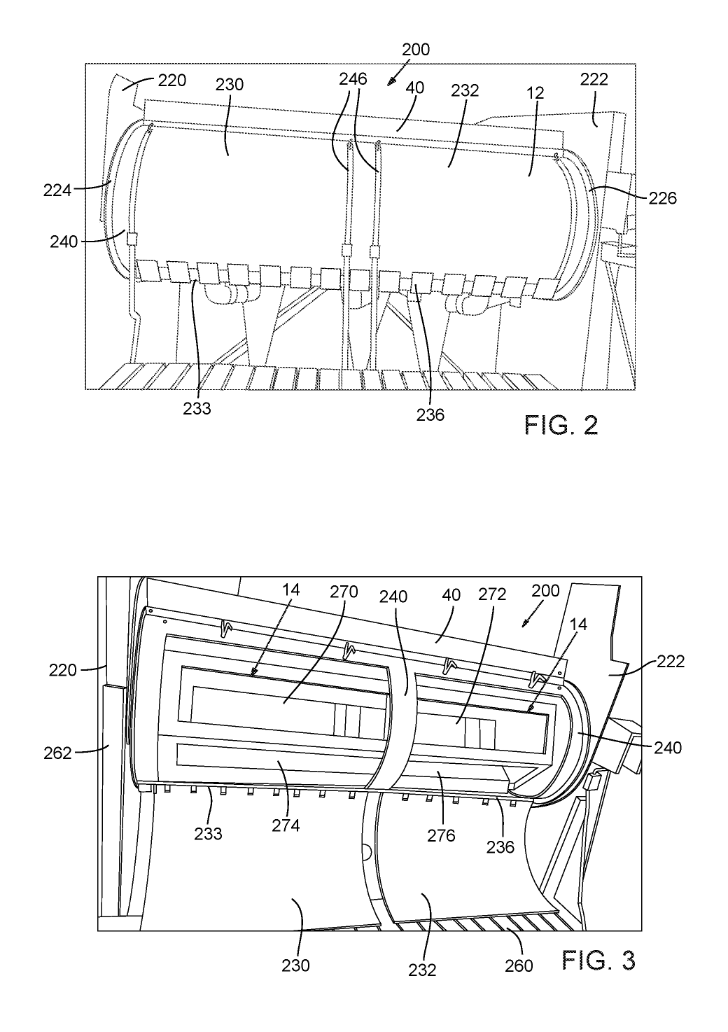

Referring to FIG. 2, in this embodiment, as indicated by the number 200, a manifold 40 is shown at the top portion of the illustrated exterior or first chamber 12. The first chamber 12 is closed by respective first and second end walls 220, 222. The illustrated first chamber 12 comprises, in this example, a right cylindrical wall 240 with respective end flanges 224, 226 bolted to the adjacent respective end walls 220 and 222. In one specific example, the first chamber can be forty-eight inches in diameter and one hundred and thirty-two inches long, with three outlets 44 that are six inches in diameter. The outlets can be positioned centered along a line at the bottom of the first chamber 12. In addition, the outlets can have a varied spacing. For example, the spacing between the end walls of the first chamber and the adjacent outlets can be less than the spacing between the outlets adjacent to the end walls and the center outlet. As a specific example, in the example of a one hundred thirty-two inch long first chamber, the center of a first outlet can be twenty-two inches from the first end wall, the center of a second outlet can be twenty-two inches from a second end wall opposite to the first end wall and a third outlet can have its center midway between the centers of the first and second outlets, such as forty four inches from the centers of the first and second outlets.

The illustrated first chamber 12 comprises first and second doors 230, 232. Door 230 is pivotally coupled by a hinge 233 to a lower portion of the wall 240 of the first chamber 12. The door 232 is pivotally coupled by hinge 236 to the wall 240. In the illustrated embodiment, latches or other closure elements, such as straps 246 (only two of which are numbered in FIG. 2) are utilized to hold the doors closed during operation of the apparatus.

In FIG. 3, the embodiment 200 is shown with the doors 230, 232 open. A deck or other stop 260, can be used to limit the extent to which the doors open. The illustrated interior second chamber 14 comprises a frame or wall 262 with a plurality of openings spaced around the perimeter of the frame. In FIG. 3, two of such side by side openings 270, 272 are visible at the front of the second chamber 14 and two additional openings 274, 276 are visible below the openings 270, 272. These openings are separated by a frame portion of the inner chamber. The second chamber 14 can be hexagonal with six sides and with a respective side by side pairs of openings positioned at each side of the chamber.

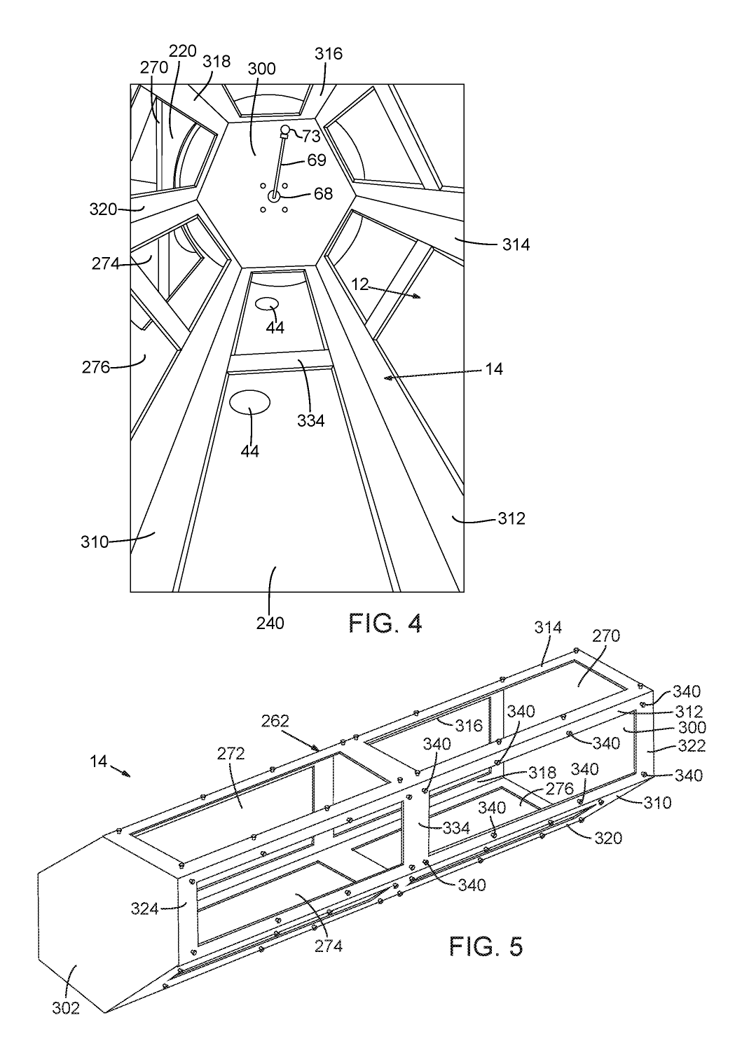

FIG. 4 illustrates the interior of an exemplary form of the second chamber 14. With reference to FIGS. 4 and 5, the illustrated second chamber can comprise a drum with first and second end walls 300,302. In these FIGS. 4 and 5, the end walls 300, 302 are hexagons with equal sizes, although they can be round or of other shapes. Longitudinally extending frame members interconnect the end walls 300, 302. These frame members are indicated at 310, 312, 314, 316, 318, and 320 in FIGS. 4 and 5. The illustrated frame members are angular and are respectively connected to the end walls 300, 302 with a portion of each frame member at opposite sides of the adjacent corner of the end wall. The respective ends of the frame members are joined by cross members that are also connected to the end walls. In FIG. 5, two such cross members are indicated at 322 and 324. Cross member 322 is connected along a side edge to end wall 300 and extends between frame members 310, 312 adjacent to end wall 300. Cross member 324 is connected along a side edge to end wall 302 and extends between frame members 310, 312 adjacent to end wall 302. A central portion of each of the frame members can also be joined together by cross members, such as indicated at 334 for a cross member extending between frame members 310, 312. The other frame members can be connected together by respective cross members in the same manner.

In FIG. 4, the cooling fluid flow conduit 69 is shown together with a coupling 73 to which the conduit section 71 is connected. The conduit 68 extends through the end wall 300 at the axis of the end wall about which the second chamber 14 is rotated. The conduit 68 is stationary relative to the second chamber. The conduit 69 extends upwardly from the conduit 68 to the upper portion of the second chamber.

In FIG. 5, filter structure fasteners, such as bolts, with some being numbered as 340 in FIG. 5, are provided at spaced locations along the frame members adjacent to the openings bounded by the frame members and cross members. In FIG. 5, four such bolts 340 are shown above and below the opening 276.

The frame members and cross members surround respective openings extending from the interior to the exterior of the second chamber 14. A side by side opening can therefore be provided defined by the frame members and cross members at each side of the interior chamber. Thus, two such pairs of openings are indicated at 270, 272 and 274, 276 in FIG. 5. Although they can be of other shapes, these openings can be rectangular as illustrated. Referring again to FIG. 4, two outlet openings 44 are shown passing downwardly through the wall 240 of the first chamber 12.

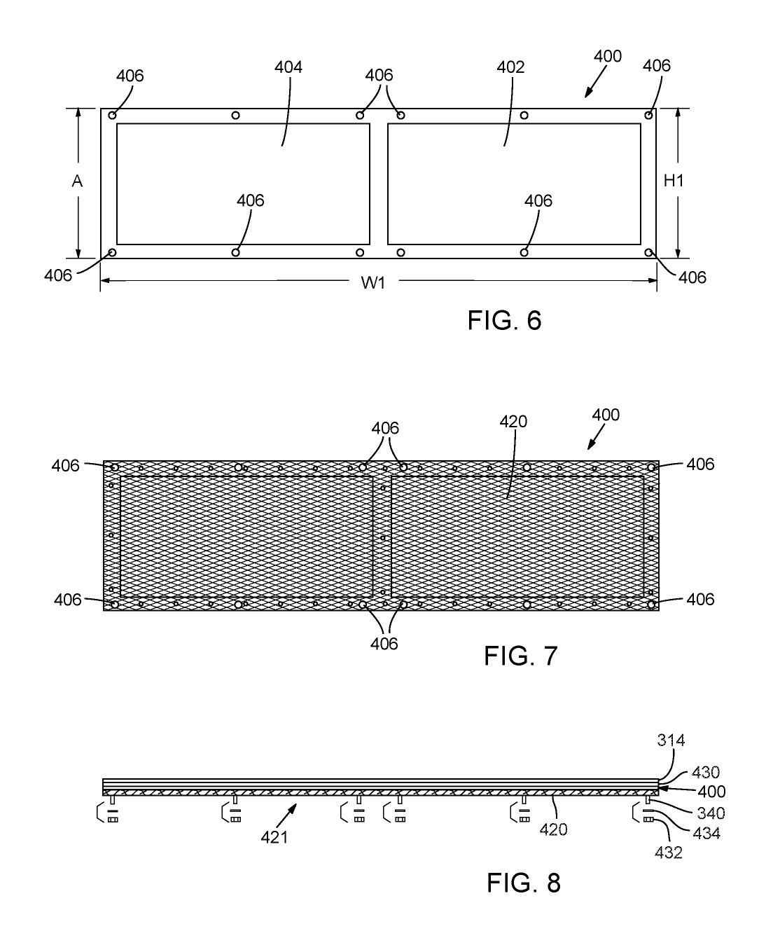

With reference to FIG. 6, a filter frame 400 is shown comprising first and second openings 402, 404. The frame has respective fastener receiving openings; two of which are indicated by the number 406 in FIG. 6. The width W1 and height H1 of the frame 400 can be varied and is desirably sized larger than the width and height of the openings in the second chamber 14 to be covered by filter material. In one example, the width W1 can be fifty-six inches and the height H1 can be 15 inches.

FIG. 7 illustrates the frame 400 with a filter supporting screen 420 shown mounted, such as by welding, to the frame 400. The frame 400 and screen 420 supports filter material 430 and is secured in place to cover an opening in the second chamber 14 through which trichome material is to pass. A respective filter structure comprising a frame 400, screen 420 and filter material is positioned to overlie each of the openings of the second chamber.

FIG. 8 illustrates a portion of one such filter structure 421 coupled to the frame member 314 of the second chamber. In this example, bolts 340 are inserted through the filter frame openings 406 with the filter structure held in place by nuts 432 and washers 434 coupled to the respective bolts 340.

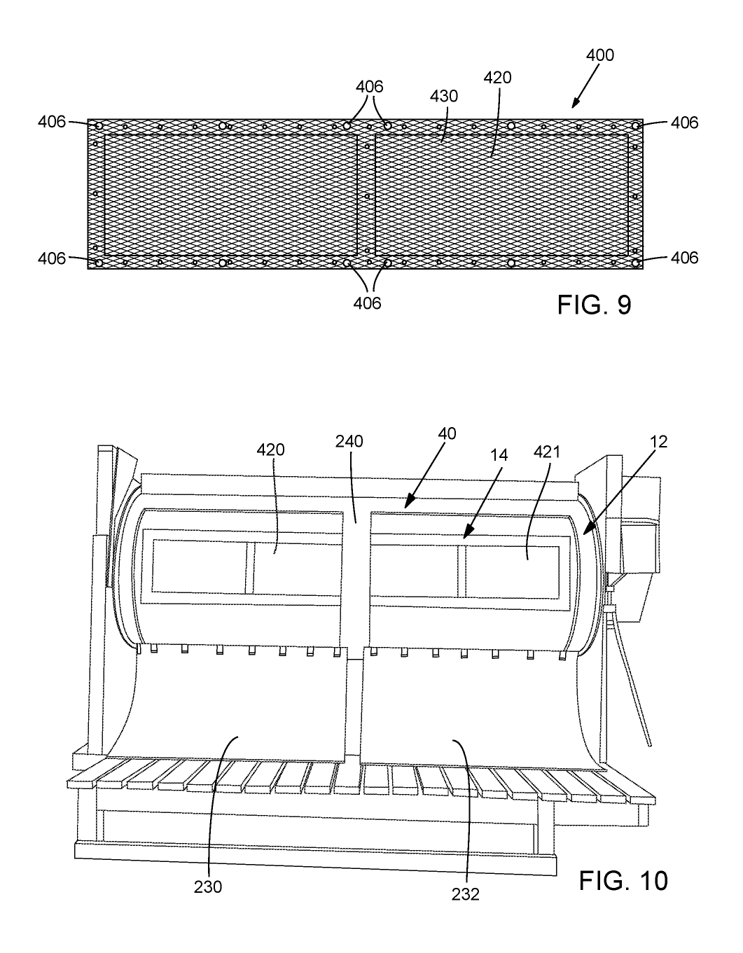

FIG. 9 illustrates one of the frames 400 with a diamond pattern mesh 420 mounted thereto with bolt receiving openings, one of which is numbered as 406 in FIG. 9.

FIG. 10 illustrates the apparatus of FIG. 2 with the doors 230, 232 open and the filter structures (one being numbered as 421 in FIG. 10) in place to cover the openings of the second chamber 14.

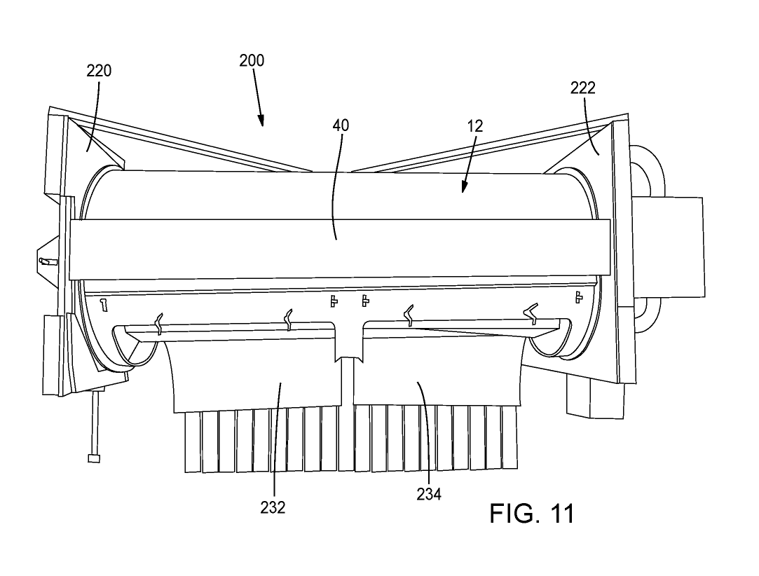

FIG. 11 is a top view of the embodiment 200 showing the first or outer chamber 12, the manifold 40 and the respective doors 232, 234 in an open position.

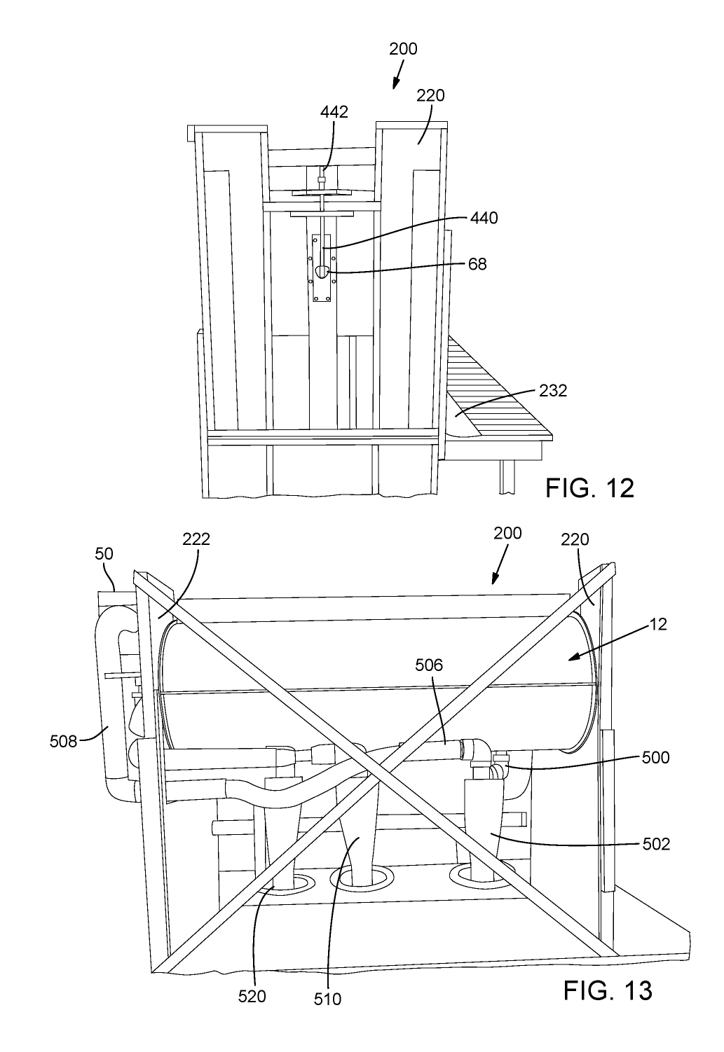

FIG. 12 depicts the apparatus 200 looking toward the end wall 220. In this figure, one can see the location at which conduit 68 enters the inner chamber. A conduit riser 440 is shown coupled to the conduit 68. The conduit riser terminates in a coupler 442 for connection to a source of cooling fluid.

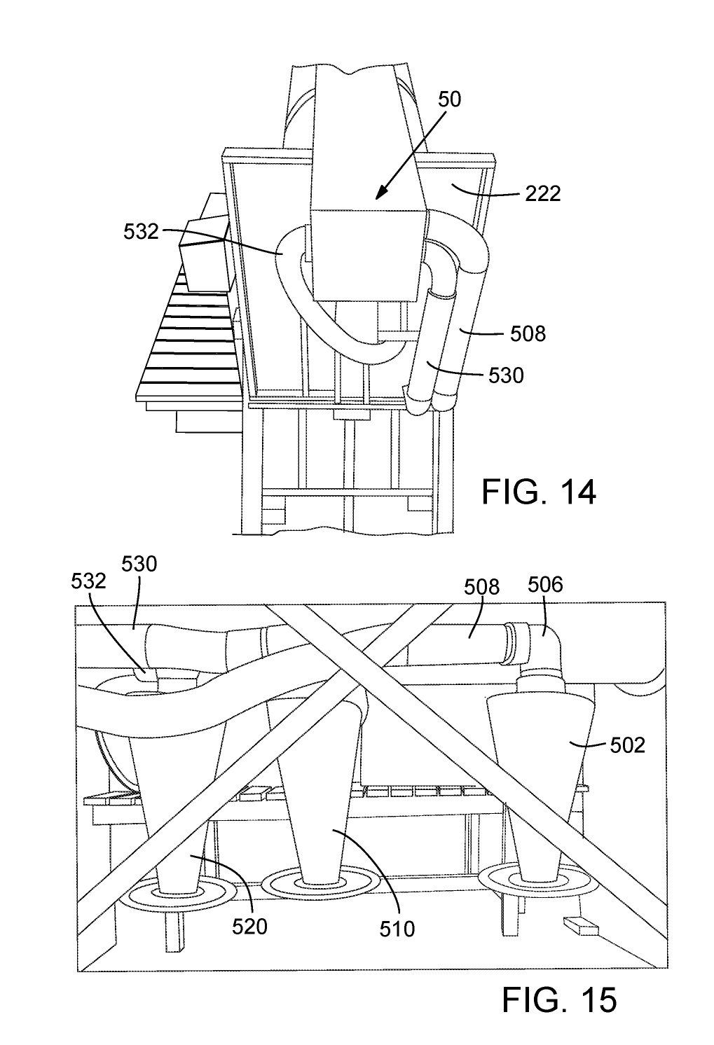

FIG. 13 is a back view of the apparatus 200 and the first chamber 12. In this view, and referring also to FIGS. 14 and 15, one can see a first conduit 500 coupled from a first chamber outlet 44 adjacent to one end (end 220) of the first chamber 12 to a side inlet of a first cyclone separator 502. A conduit section 506 extends from a top outlet of the separator 502 to a conduit section 508 that corresponds to a portion of the conduit 82 in FIG. 1, and from there to the fan 50. A second cyclone separator 510 has a side inlet coupled to a central outlet 44 of the first chamber 14 and a top outlet coupled by a conduit 530 to an inlet to the fan 50. A third cyclone separator 520 has a side inlet coupled to a third outlet 44 of the first chamber 14 adjacent to the end 222 of the first chamber 14 and a top outlet coupled by a conduit 532 to an inlet to the fan 50. More or fewer separators can be used. It should be noted that in FIG. 15, the collection containers 90 (FIG. 1) have been removed from the product outlets of the cyclone separators 502, 510 and 520 for convenience, but would be present during operation of the cyclone separators.

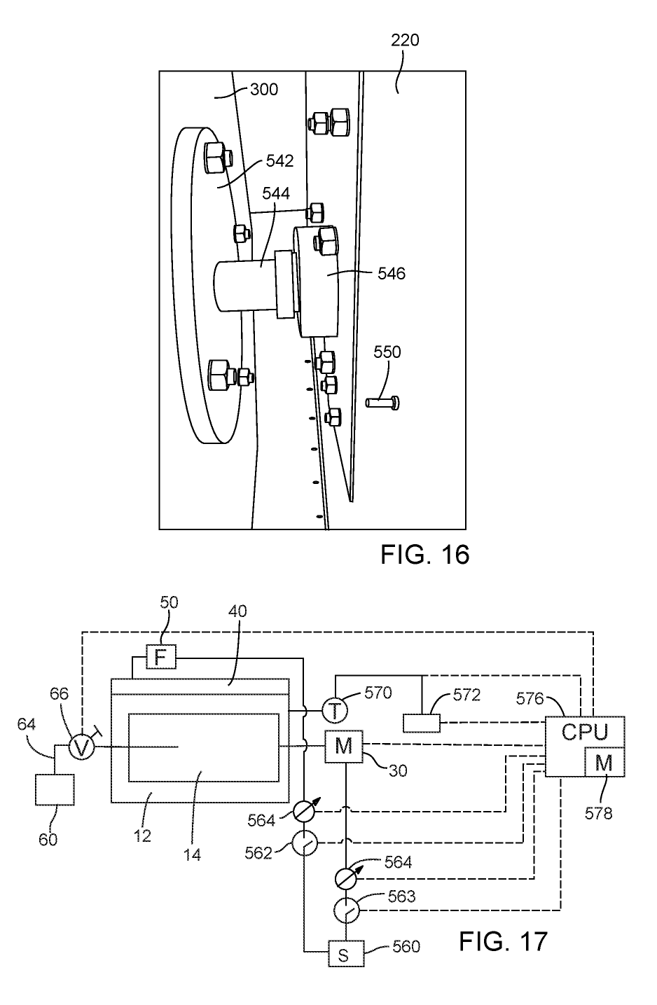

FIG. 16 illustrates an exemplary support for the ends 300, 302 of the second chamber, in this example an interior chamber that is rotatable relative to the first chamber and rotates within the first chamber; in this example the exterior chamber surrounds the interior chamber. In this example of a support, a mounting plate 542 is secured to the end wall 300, such as by bolts. A shaft 544 is mounted to the plate 542 and coupled by a bearing 546 to the end wall 220 of the first chamber. The cooling fluid supply conduit 68 extends through the end wall 220 and through the shaft 544 to the interior of the second chamber. The opposite end of the second chamber 14 can be supported in the same manner although, in this case, the corresponding shaft 544 is a drive shaft coupled, such as by a belt or gears to a motor output shaft 30 is operable to rotate the second chamber 14.

FIG. 16 also illustrates a temperature probe access tube 550 penetrating the wall 224. A temperature probe can be inserted through tube 550 to access interior of the first chamber for use in monitoring the temperature within the apparatus.

FIG. 17 illustrates an exemplary control system for the trichome separation apparatus of FIGS. 1 and 2. In the example of FIG. 17, numbers corresponding to those shown in FIG. 1 have been used for the components of the system. In FIG. 17, this figure, a source of electrical power 560 is indicated, such as 120 Volt AC Power for electrical coupling to the fan 50 and 240 Volt three phase Power for coupling to the motor 30. The source 560 is coupled through a switch 562 and a variable fan speed controller 564 to the power input of fan 50. When switch 562 is closed the controller 564 can be used to control the flow rate of air through the apparatus. The power source 560 is also coupled through a switch 562 and a motor speed controller 564 to the motor 30. The motor 30 is coupled to the second chamber 14 and operable to rotate the second chamber in this example. The rate of rotation of the second chamber 14 can be controlled by the motor speed controller 564, such as from zero to fifty RPM. A temperature probe 570 is shown coupled to the interior of the first chamber 12 in this example to monitor the temperature within the apparatus. A display 572 can be coupled to the temperature probe 570 via a driver circuit to display the monitored temperature. For example, rotation of the second chamber 14 can be delayed or minimized until the temperature probe shows that the cannabis material has reached a desired temperature as indirectly indicated in this example by the probe temperature. In addition, the fan can be shut off to delay air flow through the apparatus as a desired temperature is reached. Alternatively, the air flow can be started at any time. By delaying the rotation of the drum until the temperature within the chambers of the apparatus is at a desired level, such as below freezing and more desirably at or below 10 degrees Fahrenheit, undesirable sticking of trichomes to the interior surfaces of the apparatus is minimized. The above controls can be manually actuated.

Alternatively, the controls can be automatic or semiautomatic. For example, a controller, such as CPU 576, can be used to control the apparatus. The controller can be programmed to execute programming steps in response to a computer program stored in memory 578 coupled to the controller. The controller can be coupled to the fan to control fan speed as well as the on/off state of the fan such as via the switch 562 and variable fan speed controller 564. The controller can also be coupled to the motor to control the motor speed as well as the on/off state of the motor, such as via the switch 563 and motor speed controller 564. In addition, the controller can be coupled to the temperature probe 570 and to the display 572 to cause the display of parameters, such as temperature, fan speed and RPM of the second chamber. Suitable driver circuits couple the CPU to the motor, fan, temperature probe and speed controllers. The control circuit can be implemented alternatively via a hardwired circuit.

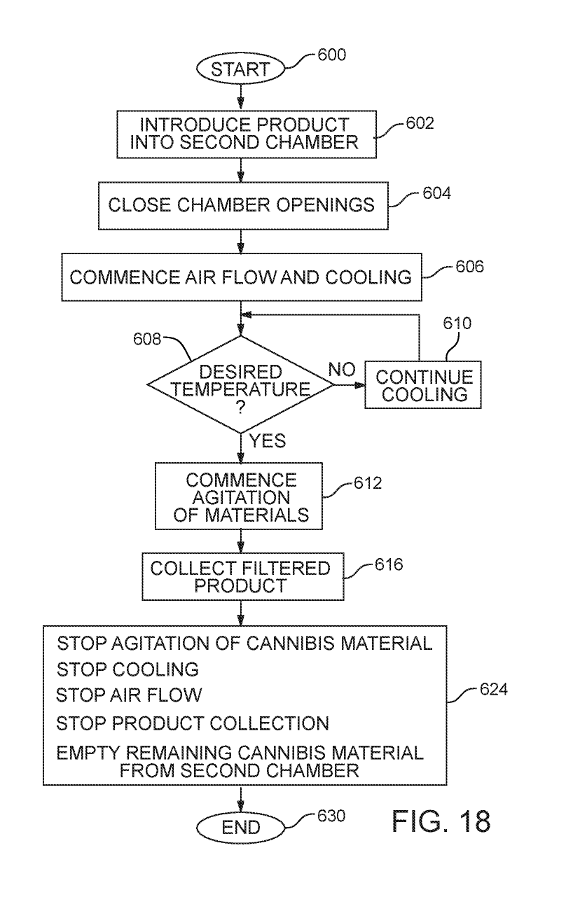

An exemplary method for separating cannabis material containing trichomes from other cannabis material is described with reference to FIG. 18. The method starts at block 600. At block 602 cannabis material is introduced into the second chamber or drum 14 via one or both of the doors 230, 232 of the first drum 12 and through one or more openings, such as openings 274, 276 leading to the second chamber 14. At 604 filter structures close the openings of the second chamber 14 through which cannabis material is introduced into the second chamber and the open doors or door 230, 232 are closed.

At block 606 cooling commences. If liquid nitrogen is used as the cooling source, delivery of liquid nitrogen is started. Also, air flow is desirably started at block 606 to assist in more rapidly cooling the interior of the system and cannabis material contained therein. The air flow can be started at alternative times, such as before or after cooling fluid flow is started and desirably before agitation of the material commences as explained below. The air flow can also less desirably be started later in the process, such as shortly after agitation commences. At block 608 a determination is made as to whether, the cannabis in the inner chamber has reached the desired temperature, such as minus ten degrees Fahrenheit. This can be indirectly determined from the temperature in the outer chamber 12. If the desired temperature has not been reached, the process continues to block 610 where it continues and loops back through block 608 until the desired temperature is reached.

When the desired temperature is reached, block 612 is reached and agitation of the material in the second chamber 14 commences; such as commencing the rotation of the second chamber 14. The second chamber can be rotated prior to the time that the desired temperature is reached, although this is a less desirable approach. The desired temperature can be maintained throughout the process.

To increase the agitation of the plant material and breaking up of the plant material being processed, the second chamber can be provided with plant lifting features that increase the tumbling of plant material within the second chamber. For example, paddles, fins, baffles, tines, flanges or other projections can project inwardly into the second chamber from the walls of the second chamber. These projections assist in lifting the material as the second chamber rotates with the material dropping from the projections as the projections are rotated toward the top of the second chamber. In addition, impact objects can be included with the plant material in the second chamber to assist in breaking up the plant material. These impact objects can, for example, be softballs, lengths of chain, or other durable chunks of material. The cannabis material can be preprocessed, such as run through a chipper or grinder prior to loading into the second chamber to further break up the material.

At block 616 the cannabis material containing trichomes that passes through the filters is collected, such as by separating the trichome containing material from the air stream using one or more cyclone separators. Less desirably, the system can use air flow to move the processed trichome containing plant material out of the first chamber and through a screen to capture the plant material containing trichomes rather than using cyclone separators. Also, gravity can be used to collect the plant material containing trichomes in a collection area; for example, the plant material containing trichomes can be allowed to settle out of the air by gravity.

The process continues to block 624. At block 624, agitation of the cannabis material is stopped; such as by stopping the rotation of the second chamber. Cooling and air flow are ended and collection of product ends. In addition, the remaining cannabis is emptied from the apparatus and the process ends at block 630.

If desired, at block 624 the collected product can be removed after the air flow and second chamber rotation is stopped. Rather than remove the remaining cannabis material, the process can be repeated on the remaining material. The collected product from this repeated process will be of a lower grade, but still useful. After a desired number of repeated processes, the process can be ended at block 630.

Having illustrated and described the principles of our invention with reference to a number of embodiments, it should be apparent to those of ordinary skill in the art that the embodiments may be modified without departing from the inventive principles disclosed here. We claim as our invention all variations that fall within the scope of the following claims.

We claim:

1. An apparatus for separating trichome containing cannabis material from cannabis plant material, the apparatus comprising:
a first chamber comprising an interior and an exterior and a first chamber access opening communicating from the exterior to the interior of the first chamber;
a second chamber comprising an interior and an exterior and a second chamber access opening, the second chamber being supported for rotation within the first chamber, wherein cannabis plant material is loadable through the first chamber access opening and through the second chamber access opening into the interior of the second chamber;
the second chamber comprising a plurality of filter receiving openings communicating between the interior and exterior of the second chamber;
a filter covering each of the filter receiving openings and sized to allow the passage of trichome sized plant material from cannabis plant material within the second chamber;
a cooling source inlet through which a cooling material that freezes cannabis material in the second chamber is delivered;
a motor coupled to the second chamber and operable to rotate the second chamber within the first chamber;
a first chamber outlet opening communicating from the interior to the exterior of the first chamber;
a fan comprising a fan inlet and a fan outlet, the fan outlet being coupled to the first chamber for directing air through the first chamber and outwardly through the at least one first chamber outlet opening; and
a cyclone separator comprising a separator inlet coupled to the first chamber outlet opening, the cyclone separator receiving air from the first chamber and collecting material, including trichomes, exiting from the second chamber through the filters, the cyclone separator comprising a separator outlet coupled to the fan inlet.

2. An apparatus according to claim 1 comprising a source of cooling fluid coupled to the cooling source inlet.

3. An apparatus according to claim 1 wherein the cooling source inlet comprises the second chamber access opening through which solidified carbon dioxide can be added as the cooling material to cannabis material in the second chamber.

4. An apparatus according to claim 1 comprising an air flow manifold comprising an air flow manifold inlet coupled to the fan outlet, the air flow manifold having at least one air flow manifold outlet coupled to the first chamber through which air from the fan entering the air flow manifold is directed into the first chamber.

5. An apparatus according to claim 4 wherein the first chamber has a first chamber longitudinal axis and a length direction along the first chamber longitudinal axis, and wherein the air flow manifold extends along a top portion of the first chamber along at least a majority of the length of the first chamber, the air flow manifold comprising an air flow manifold outlet that directs air flow downwardly from the air flow manifold into the first chamber.

6. An apparatus according to claim 1 wherein the second chamber has a second chamber longitudinal axis and a length direction along the second chamber longitudinal axis, the apparatus comprising a cooling fluid delivery conduit coupled to the cooling source inlet and extending along at least a majority of the length of the second chamber, the cooling fluid delivery conduit comprising a plurality of cooling fluid outlets along the length of the cooling fluid delivery conduit through which cooling fluid is delivered to the interior of the second chamber.

7. An apparatus according to claim 6 wherein the first chamber has a top portion, a first chamber longitudinal axis and a length direction along the first chamber longitudinal axis, and wherein the air flow manifold extends along the top portion of the first chamber along at least a majority of the length of the first chamber and comprises one or more air flow manifold outlets that direct air flow downwardly from the air flow manifold into the first chamber along a majority of the length of the first chamber, and further including a second cooling fluid delivery conduit coupled to the cooling source inlet and extending along at least a majority of the length of the air flow manifold, the second cooling fluid delivery conduit comprising a plurality of cooling fluid outlets along the length of the second cooling fluid delivery conduit through which cooling fluid is delivered to the interior of the air flow manifold for cooling air that flows from the air flow manifold into the first chamber.

8. An apparatus according to claim 1 wherein the filters comprise filters sized from 60 microns to 135 microns.

9. An apparatus according to claim 1 wherein the first chamber has a bottom portion and a length, and wherein there are a plurality of first chamber outlet openings spaced along the length of the bottom portion of the first chamber, and wherein there is a plurality of said cyclone separators each having a separator inlet coupled to a respective one of the first chamber outlet openings and a separator outlet coupled to the fan inlet.

10. An apparatus according to claim 1 wherein the motor is operable to rotate the second chamber at a rate of from 5 to 60 rpm.

11. An apparatus according to claim 1 comprising a temperature probe positioned to measure the temperature within at least one of the first chamber and the second chamber and a display for displaying the temperature.

12. An apparatus according to claim 11 comprising a motor control that is operated to rotate the second chamber after the cannabis material within the second chamber is frozen.

13. An apparatus according to claim 12 wherein the motor control is operated to rotate the second chamber after the temperature probe indicates a temperature of below zero degrees Fahrenheit.

14. An apparatus according to claim 13 wherein the motor control is operated to rotate the second chamber after the temperature probe indicates a temperature of minus 10 degrees Fahrenheit or less.

15. An apparatus according to claim 14 wherein the motor control is operated to rotate the second chamber at a rate of from 25 to 50 rpm to agitate the cannabis material in the second chamber.

16. An apparatus according to claim 1 wherein the second chamber access opening is also a filter receiving opening.

17. A method of separating cannabis material containing trichomes from cannabis material comprising:
placing trichome containing cannabis material within a chamber:
freezing the trichome containing cannabis material;
flowing air past the chamber;
agitating the frozen trichome containing cannabis material;
filtering the agitated frozen trichome containing cannabis material to allow trichome sized filtered cannabis material, including trichomes, to enter the flowing air; and
separating the filtered material from the flowing air.

18. A method according to claim 17 wherein agitating the frozen trichome containing cannabis material is accomplished by rotating the chamber containing the frozen trichome containing cannabis material.

19. A method according to claim 18 wherein flowing air is accomplished by flowing air through a second chamber that encloses the first chamber and wherein separating the filtered cannabis material comprises passing the flowing air through a cyclone separator.

20. A method according to claim 17 wherein filtering is accomplished by requiring frozen cannabis material exiting the chamber to pass through a filter sized in the range of from sixty microns to one hundred and thirty-five microns.

21. A method according to claim 17 wherein freezing the trichome containing cannabis material is accomplished by exposing the cannabis material to one or more of liquid nitrogen, liquid carbon dioxide or frozen carbon dioxide.

22. A method according to claim 17 wherein freezing the trichome containing cannabis material comprises exposing the trichome containing cannabis material to liquid nitrogen.

23. An apparatus for separating trichomes containing cannabis material from cannabis plant material, the apparatus comprising:
a first chamber comprising an interior and an exterior and a first chamber access opening communicating from the exterior to the interior of the first chamber;
a second chamber comprising an interior and an exterior and a second chamber access opening, the second chamber being supported for rotation within the first chamber, wherein cannabis plant material is loadable through the first chamber access opening and through the second chamber access opening into the interior of the second chamber;
the second chamber comprising a plurality of filter receiving openings communicating between the interior and exterior of the second chamber;
a filter sized in the range of from 60 microns to 135 microns covering each of the filter receiving openings;
a cooling source inlet for receiving cooling material through the inlet that freezes cannabis material in the second chamber;
a motor coupled to the second chamber and operable to rotate the second chamber within the first chamber;
a plurality of first chamber outlet openings communicating from the interior to the exterior of the first chamber;
a fan comprising a fan inlet and a fan outlet, the fan outlet being coupled to the first chamber for directing air downwardly through the first chamber and outwardly through the plurality of first chamber outlet openings; and
a plurality of cyclone separators each comprising a separator inlet coupled to a first chamber outlet opening that receives air from the first chamber, the cyclone separators collecting material, including trichomes, exiting from the second chamber through the filters, the cyclone separators also each comprising a separator outlet coupled to the fan inlet;
an air flow manifold comprising an air flow manifold inlet coupled to the fan outlet, the air flow manifold having at least one air flow manifold outlet coupled to the first chamber through which air from the fan is directed downwardly into the first chamber.
wherein the second chamber has a second chamber longitudinal axis and a length direction along the second chamber longitudinal axis, the apparatus comprising a cooling fluid delivery conduit coupled to the cooling source inlet and extending along at least a majority of the length of the second chamber, the cooling fluid delivery conduit comprising a plurality of cooling fluid outlets along the length of the cooling fluid delivery conduit through which cooling fluid is delivered to the interior of the second chamber; and
a motor control that is operated to rotate the second chamber after the cannabis material within the second chamber is frozen and wherein the motor control is operated to rotate the second chamber at a rate of from 5 to 60 rpm to agitate the cannabis material in the second chamber.

24. An apparatus according to claim 23 comprising a source of cooling fluid coupled to the cooling source inlet.

25. An apparatus according to claim 23 wherein the first chamber has a top portion, a first chamber longitudinal axis and a length direction along the first chamber longitudinal axis, and wherein the air flow manifold extends along the top portion of the first chamber along at least a majority of the length of the first chamber and comprises one or more air flow manifold outlets that direct air flow downwardly from the air flow manifold into the first chamber along a majority of the length of the first chamber.
